(19) United States
(12) Patent Application Publication
(10) Pub. No.: US 2025/0039142 A1
(43) Pub. Date: Jan. 30, 2025

(54) MEASURING FILES BASED ON FILE PROPERTY-BASED SELECTION CRITERIA

(71) Applicant: HEWLETT PACKARD ENTERPRISE DEVELOPMENT LP, Spring, TX (US)

(72) Inventors: Isaac J. Matthews, Bristol (GB); Nigel J. Edwards, Bristol (GB); Geoffrey Ndu, Bristol (GB)

(21) Appl. No.: 18/359,057

(22) Filed: Jul. 26, 2023

(51) Int. Cl. H04L 9/40

(52) U.S. Cl. CPC H04L 63/0263

(57) ABSTRACT

A technique includes registering, with a core of an operating system kernel, a hook that corresponds to a file event and associates the file event with an event-driven module of the operating system kernel. The core is associated with an integrity measurement architecture policy. The technique includes, responsive to an occurrence of the file event, triggering execution of the event-driven module to extend a scope of the integrity measurement architecture policy. Executing the module includes the operating system kernel determining a property of a file that is associated with the file event; and filtering a set of rules of an extended integrity measurement policy based on the property. The filtering includes identifying a given rule of the set of rules having a condition that is contingent on the file event being associated with the property. Executing the module includes the operating system kernel identifying an integrity measurement-affiliated action of the given rule and performing the integrity measurement-affiliated action on the file.

### BACKGROUND

A computer platform may be subject to a security attack for such nefarious reasons as an attacker seeking access to information that is stored on the computer platform or an attacker seeking to harm components of the computer platform. A computer platform may have various security measures for such purposes as preventing a security attack, inhibiting the degree of harm inflicted by any such security attack and instilling confidence that the computer platform may be trusted. For example, a computer platform may be protected by a firewall and other mechanisms that restrict access to the computer platform based on cryptographic security parameters. As another example, a computer platform may have malware protection software that scans directories, searching for malware agents. As another example, a computer platform may have an operating system-based integrity measurement architecture to measure software components. The measurements may be beneficial for such purposes as identifying software components that have been compromised, preventing compromised executables from being executed and providing evidence that may be used to verify whether the computer platform is trustworthy.

### BRIEF DESCRIPTION OF THE DRAWINGS

FIG. 1 is a block diagram of a computer platform having an operating system (OS) kernel-based extended integrity measurement engine according to an example implementation.

FIG. 2 is an illustration of an extended integrity measurement engine's evaluation of a file based on rules contained in an extended integrity measurement policy according to an example implementation.

FIG. 3 is a flow diagram depicting a process performed by an operating system kernel that includes an extended integrity measurement engine according to an example implementation.

FIG. 4 is a flow diagram depicting a process used by an extended integrity measurement engine to apply an extended integrity measurement policy that has a namespace-based selection criterion according to an example implementation.

FIG. 5 is a flow diagram depicting an operating system-based technique to perform an action based on a file property-based selection criterion of an integrity measurement policy according to an example implementation.

FIG. 6 is an illustration of machine-readable instructions that, when executed by a machine, cause an operating system kernel to selectively measure a file based on a namespace or a file path associated with an event corresponding to the file, according to an example implementation.

FIG. 7 is a block diagram of a system that includes an operating system kernel core to measure first files in accordance with a first measurement policy and an event-driven module to selectively measure a second file based on a property of the second file, according to an example implementation.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

The terminology that is used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

A computer platform may, during the platform's boot and in the platform's runtime environment, take integrity measurements of various software components. In this context, a “software component” (also referred to as a “component” herein) refers to a referenceable unit of data, such as a file, an image, or content contained in a logical volume. The integrity measurements may serve any of a number of different purposes. For example, an operating system kernel (herein called the “kernel”) of a computer platform may measure an executable file before the kernel loads and executes the file for purposes of ensuring that the file has not been compromised (e.g., compromised due to corruption or tampering). The kernel may, for example, compare an integrity measurement of an executable file to a trusted, reference integrity measurement for the executable file, and the kernel may not load and execute the executable file if these integrity measurements do not match. As another example, a remote verifier may determine, based on an authenticated digest of integrity measurements of a computer platform, whether the computer platform may be trusted.

The kernel of a computer platform may measure a software component by applying a cryptographic hash function to the content of the software component to produce a hash value (or “hash”) that represents the integrity measurement. Due to the nature of cryptographic hash functions, any minute change to the software component's content causes the resulting hash value (the integrity measurement) to differ from a reference hash value (the reference integrity measurement). Therefore, such hash-based integrity measurements provide a highly reliable way to detect whether software components have been altered and document evidence that may be used to evaluate whether a computer platform is trustworthy.

A computer platform may have a built-in integrity measurement architecture (IMA), and as part of the IMA architecture, the kernel may, in the computer platform's runtime environment, collect integrity measurements of software components. Here, the “runtime” environment refers to the state of the computer platform after boot when control of the platform has been passed to the operating system. An IMA policy generally defines criteria that controls which software components are measured by the kernel. A particular IMA policy may have a set of statements, or rules, where each rule defines an integrity measurement-related action (or “integrity measurement-affiliated action”) and a condition for triggering the action. In an example, a measurement-related action may be an integrity measurement. In another example, an integrity measurement-related action may be an appraisal of an integrity measurement. Existing IMA policies may have constraints (herein called the “IMA policy constraints”), such as constraints that are imposed by IMA policy syntax and/or semantics, which prevent IMA policy rules from specifically covering all files that may be considered important, whether from the standpoint of computer platform security or otherwise. The IMA policy constraints may result in the use of overly-broad IMA policy rules that collect unnecessary integrity measurements for purposes of ensuring that certain important files are measured. Moreover, the IMA policy constraints may result in IMA policy rules that are unduly narrow in scope and do not cover integrity measurements of some important files.

The IMA policy constraints may prevent the implementation of a policy rule that covers a specific non-executable file or a specific class of non-executable files. In this context, an “executable file” (also called a “directly-executable file” herein), refers to a file that contains machine code (also called “binary code”) that may be directly executed by a hardware processor of the computer platform without further modification (e.g., executed without compilation, interpretation or further pre-processing being applied first to derive the machine code). A directly-executable file is a file that contains machine code, and a hardware processor executes the machine code, and stated differently, the kernel may execute the directly-executable file. A “non-executable” file, in the context used herein, refers to a file other than a directly-executable file.

There may be a number of reasons to verify the integrities of specific non-executable files or specific classes of non-executable files. For example, some non-executable files may be important to the state of a computer platform and may present potential security attack surfaces. For example, the system configuration of a computer platform and the configuration of various applications and hardware devices of a computer platform may rely on configuration files, which are non-executable files. Unintentional misconfiguration of a computer platform due to a configuration file containing incorrect configuration information or intentional misconfiguration of a computer platform due to a configuration file being compromised as a result of tampering may lead to any of a number of adverse results. As examples, these adverse results may include the computer platform being exposed due to security vulnerabilities, the computer platform being subjected to security attacks, the computer platform having an unacceptable system performance, the entire computer platform being shut down, the computer platform being quarantined from a network, the computer platform being considered untrustworthy, or certain computer platform functions being unusable.

An interpreted file is another example of a non-executable file that may be important to the state of a computer platform. In this context, an “interpreted” file refers to a file that contains content written in a programming language that is to be interpreted, or transformed, by an interpreter. Stated differently, an interpreted file does not contain machine code that may be directly executed. In an example, an interpreter, which processes interpreted files, may be a directly-executed file. When executed, the interpreter may transform statements of an interpreted file, line by line, into machine code, which is then executed. An unintentionally or intentionally compromised interpreted file may have a relatively large impact on the security of a computer platform, even though the interpreted file itself is not directly executed.

Some non-executable files may not affect the state of a computer platform, but verifying the integrities of these files may nevertheless be considered important. In an example, a build process on a computer platform may construct a software product to be distributed. Integrity measurements may be beneficial for purposes of detecting tampering in the build process. For example, it may be important to verify the integrities of downloaded files that are used in the build process.

Within the IMA policy constraints, IMA policy rules may be defined, which trigger integrity measurements of files responsive to certain file events. As used herein, a “file event” refers to a kernel action involving a file. For example, a file event may be the execution of a file by the kernel, and an IMA policy rule may contain an execute mask for purposes of causing the kernel to collect integrity measurements of files that are to be executed by the kernel before the kernel loads and executes the files. As noted above, the IMA policy constraints do not allow IMA policy rules that cover specific non-executable files or specific classes of non-executable files. Therefore, for example, although an IMA policy may contain a rule that has an execute mask that triggers a measurement for an interpreter, which is a directly-executed file, due to the IMA policy constraints, an IMA policy rule may not be constructed to trigger a measurement of a specific interpreted file that is interpreted by the interpreter. It is possible that an interpreted file may be compromised, although an integrity measurement of the interpreter that processes the interpreted file may confirm or verify the integrity of the interpreter.

A policy rule may be defined, within the IMA policy constraints, which covers measurements for a specific volume (e.g., a logical volume). Accordingly, one approach to construct an IMA policy that covers measurements for certain non-executable files may involve constructing one or multiple rules in the IMA policy to measure certain volumes that contain the non-executable files. However, this approach results in a single integrity measurement for each volume. A single integrity measurement may be associated with a considerable amount of measurement “noise.” In this manner, even a minute change to a component of the volume (e.g., a relatively unimportant file or image being updated, deleted or added) alters the volume's integrity measurement and may result in the integrity measurement differing from the expected reference integrity measurement for the volume. Therefore, although some of the volume's components may be considered unimportant (in terms of platform security or for some other reason), any change(s) to these components may nevertheless result in the volume failing integrity verification.

Another approach to construct an IMA policy that covers integrity measurements of certain non-executable files may involve including a rule in the IMA policy that covers a particular file event that may occur with all files. For example, an IMA policy rule may contain a read mask for purposes of triggering integrity measurements of all files that are to be read by the kernel. In another example, a rule may contain a write mask for purposes of triggering integrity measurements of all files that are to be written by the kernel. Such rules, however, due to their relatively non-selective natures, may place a significant burden on the computer platform's integrity measurement architecture.

In accordance with example implementations that are described herein, an operating system kernel has an extended integrity measurement architecture that is controlled by a policy (called “an extended integrity measurement policy” herein) that allows rules that cover integrity measurements for specific non-executable files. In accordance with example implementations, an extended integrity measurement policy may contain a rule that specifies at least one of a file property-based selection criterion or a context-based selection criterion for purposes of selecting a file or a class of files for an integrity measurement-related action. As examples, the file property-based selection criterion may specify a particular file property, such as a particular filename (also called a “file name”), a filename pattern, a file modification date, a file type, or another file property, for purposes of selecting a particular file or a particular class of files. In an example, file property-based selection criterion may include a comparison operator (e.g., an equal operator, a less than operator, a greater than operator or other comparison operator) and a file property reference (e.g., a reference file creation date) such that if the file property meets the comparison (e.g., a file creation date is more recent than a reference file creation date), then the criterion is satisfied. In another example, a file property-based selection criterion may specify a regular expression (or “regex”) that identifies a filename pattern, such that if the filename has the filename pattern, then the criterion is satisfied. In an example, a context-based selection criterion may be a file path. In another example, a context-based selection criterion may be a particular namespace that is associated with an entity requesting access to a file. In an example, a context-based selection criterion may specify a context (e.g., a certain namespace, a full file path or a partial file path) associated with the file event, such that if the file event is associated with the specified context (e.g., a requestor of access to a file is associated with the specified namespace or a file is stored in a location correspond to a particular file path), the criterion is satisfied. For a condition that contains multiple context-based selection criteria, whether or not a condition of a rule is satisfied may depend on the result of a logical combination of the criteria.

The file property-based selection criterion or criteria establish a condition of the rule, which if satisfied for a particular file, result in an integrity measurement-related action (which is also specified by the rule) being performed on the file. For a condition that contains multiple file property-based selection criteria, whether or not a condition of a rule is satisfied may depend on the result of a logical combination of the criteria. In an example, a condition that has multiple file property-based selection criteria may be satisfied if all of the criteria of the condition are satisfied (e.g., a logical AND of the criteria results in a Boolean True result). In another example, a condition that has multiple file property-based selection criteria may be satisfied if one of the criteria is satisfied (e.g., a logical OR of the criteria results in a Boolean True result). In an example, whether or not a condition that has multiple file property-based selection criteria is satisfied may depend on a logical expression that is relatively more complex than a single AND or OR operator. As examples, the measurement-related action may be an integrity measurement or an appraisal.

A particular rule of the extended integrity measurement policy may contain a condition that includes zero, one or multiple file property-based selection criteria, and this condition may include zero, one or multiple context-based selection criteria. For a condition that contains multiple selection criteria (e.g., file property-based selection and context-based selection criteria), whether or not the condition is satisfied may depend on the result of a logical combination of the criteria.

As a more specific example, a rule for selecting a specific configuration file or a specific class of configuration files may contain a condition that specifies that a file that has a “.cfg” filename extension (a file property-based selection criterion) and a file creation date on or after a certain date (a file property-based selection criterion) is selected for a measurement-related action. In another example, a rule for selecting a specific interpreted file or a specific class of interpreted files may contain a condition that specifies that a file that has a “.py” PYTHON filename extension (a file property-based selection criterion), a file creation date after a certain date (a file property-based selection criterion) and is stored at a location that corresponds to a particular file path (a context-based selection criterion) is selected for a measurement-related action.

A “file property,” in the context that is used herein, refers to an attribute, or characteristic, of a file. In an example, a file property may be a filename, and a “file property-based selection criterion” refers to a particular characteristic or class of characteristics of a file. A file property-based selection criterion may, for example, identify a specific file by its complete filename. In another example, a file property-based selection criterion may identify a particular part or pattern of a filename (e.g., a particular filename extension or particular pattern of alphanumeric characters appearing in the main filename) for purposes of identifying a particular group, or class, of file having the filename part of pattern. In an example, a file property-based selection criterion may be in the form of a particular regular expression (or “regex”) or a numerical comparison.

In another example, a rule of the extended integrity measurement policy may contain a file property-based selection criterion other than a filename-based criterion. In an example, a file property-based selection criterion may be a certain file permission, such as an execute permission. This may be particularly advantageous for bringing certain files into the integrity measurement scope. Although a non-executable file may have an execute permission, traditional IMA policy constraints do not allow a rule to specifically cover the file because the file is not directly executed, and therefore, the file would not be covered by the mere inclusion of an execute mask in an IMA policy rule. However, with the extended integrity measurement policy, a rule may, for example, specify that any file having an execute permission is to be measured, which covers non-executable files that have execute permissions. In an example, a rule of the extended integrity measurement policy may specify that a measurement-related action is to be performed for any file that has a certain whole or partial filename (e.g., a filename extension of “.sh,” which targets shell script files) and an execute permission.

In another example, a file property-based selection criterion may be a particular file type (e.g., a particular LINUX file type). As other examples, a file property-based selection criterion may be a file creation date, a file modification date or a file last access date. In an example, for purposes of selecting a class of files added to a computer platform after a certain date, a file property-based selection criterion may select file creation dates after a certain reference date. In another example, a file property-based selection criterion may be a particular file size. For example, for purposes of selecting a class of files above a certain size for measurement, a file property-based selection criterion may be a numerical comparison to select file sizes above a specified minimum size.

As used herein, a “context” refers to an attribute, or characteristic, of the environment associated with a file event, and a “context-based selection criterion” refers to a particular characteristic or class of characteristics of the environment of a file event. In an example, a context-based selection criterion may be a particular file path or class of file paths in which a file is to be measured is stored. As examples, a context-based selection criterion may define a specific file path and may or may not include child paths of the specific file path. As another example, a context-based selection criterion may be a namespace (e.g., a process namespace or a user namespace) associated with the requestor (e.g., a host or a container) of the file event.

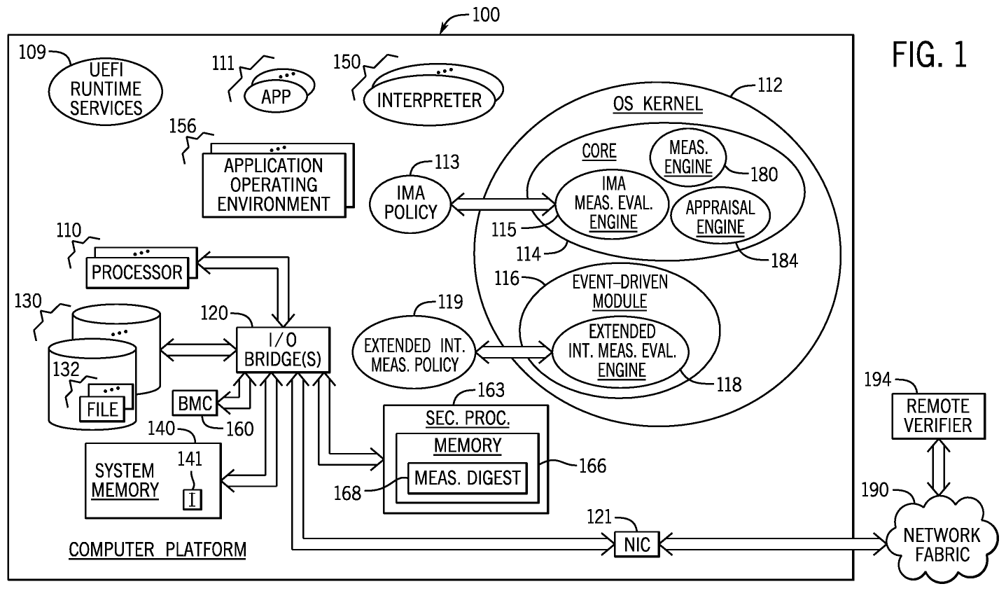

As a more specific example, FIG. 1 depicts a computer platform 100 in accordance with example implementations. The computer platform 100 may have one of a number of different potential architectures, in accordance with many possible implementations. Regardless of its particular architecture, a “computer platform” in the context used herein, is a processor-based electronic device, which has an operating system that includes an integrity measurement architecture. As examples, a computer platform may be a standalone server, a rack-mounted server module; an edge processing, rack-mounted module; a server blade; a blade enclosure containing one or multiple server blades; a client; a thin client; a desktop computer; a portable computer; a laptop computer; a notebook computer; a tablet computer; network device, a network switch, a gateway device, a smartphone; a wearable computer; or other platform.

The computer platform 100 may have include one or multiple hardware processors 110 (e.g., one or multiple central processing units (CPUs), one or multiple CPU processing cores, one or multiple graphics processing units (GPUs), one or multiple GPU processing cores, and other hardware processors); and a system memory 140. The system memory 140 and other memories discussed herein are non-transitory storage media that may be formed from semiconductor storage devices, memristor-based storage devices, magnetic storage devices, phase change memory devices, a combination of devices of one or more of these storage technologies, and so forth. The system memory 140 may represent a collection of memories of both volatile memory devices and non-volatile memory devices.

The system memory 140 includes a user space and a kernel space. The kernel space represents locations of the system memory 140, which store machine-readable instructions, data and data structures corresponding to an operating system kernel 112 (also called the “kernel 112” herein). The user space represents locations of the system memory 140, which are used by non-operating system kernel processes, or user processes, such as processes that correspond to executing instances of applications 111, virtual machine instances, container instances, as well as other processes.

The system memory 140 may store machine-readable instructions 141 that are executed by the processors 110 to form various components of the computer platform 100. In an example, during a runtime environment of the computer platform 100, one or multiple processors 110 may execute instructions 141 associated with the kernel 112. In another example, during the runtime environment, one or multiple processors 110 may execute instructions 141 associated with applications 111. In another example, during the runtime environment, one or multiple processors 110 may execute instructions 141 associated with Unified Extensible Interface (UEFI) runtime services.

As depicted in FIG. 1, in accordance with example implementations, the kernel 112 includes a core 114. In an example, the core 114 may be a compiled operating system kernel, and in accordance with further examples, the core 114 may part of a commercially-available operating system package. In examples, the core 114 may include any or some combination of the following: a LINUX operating system, a MICROSOFT WINDOWS operating system, a MAC operating system, a FREEBSD operating system, or other operating system.

The core 114 may perform a variety of different operations on, with and/or using files 132 in connection with file events. As used herein, a “file” refers to a container of information. In an example, a file 132 may be associated with a file system, which is method and data structure to organize a collection of files. In an example, files 132 in a file system may be organized using a directory, which is a hierarchical structure, or tree; and the location of a file within the file system may be identified by a corresponding file path. In an example, a file system may be a physical file system in which files conform to a particular data storage format. In another example, a file system may be a virtual file system which may be an upper file system layer of a composite file system that includes lower layer physical file systems that are accessed through the virtual file system. In an example, the computer platform 100 may have a root file system, which contains files to boot the computer platform 100, and other files systems may be mounted at mount points corresponding to subdirectories of the root file system.

As depicted in the example implementation of FIG. 1, files 132 may be stored in one or multiple storage devices 130 (e.g., mass storage devices, persistent memories, a storage array or other storage devices) of the computer platform 100. A given file 132 may be stored in various other locations, however. In an example, a given file 132 may be stored in whole or in part in the system memory 140. In another example, a given file 132 may be stored in a memory of a hardware device of the computer platform 100. In another example, a given file 132 may be stored in a network-attached storage device.

In an example, a file event may be an operating system operation to access a file 132. In this context, “accessing” a file may refers to reading content from a file 132, writing content to a file 132, executing a file 132 or linking to a file to another directory location. In an example, a file event may be the response of the core 114 to a system call to read, write, execute or link a particular file 132. In another example, a file event may be an operating system operation in which the core 114 responds to a system call to memory map a file 132. In another example, a file event may be an operating system operation that occurs as part of the core's execution of a particular file 132.

System calls to initiate file events may be issued by executing entities, such as applications 111 and interpreters 150 (which are a specific type of application 111 discussed herein). Applications 111 may execute as part of a host of the computer platform 100, and applications 111 may execute inside application operating environments 156 of the computer platform 100. In this context, a “host” refers to an environment associated with an unabstracted view of system resources (e.g., the system memory 140, the processors and the operating system 112) of the computer platform 100. An “application operating environment” refers to a domain in which executing applications inside the domain have abstracted views of system resources. A given application 111 may be a monolithic application or may be a non-monolithic application decomposed into a set of microservices.

An example of an application operating environment 156 is a container. A container, in general, is a virtual run-time environment for one or multiple applications and/or application modules, and this virtual run-time environment is constructed to interface to the kernel 112. A container for a given application may, for example, contain the executable code for the application and its dependencies, such as system tools, libraries, configuration files, executables and binaries for the application. The container contains an operating system kernel mount interface but not include an operating system kernel. As such, the computer platform 100 may, for example, contain multiple containers that share the kernel 112 through respective operating system kernel mount interfaces. Docker containers and rkt containers are examples of containers. The computer platform 100 may contain a container supervisor (not shown), also referred to as a container engine daemon, which performs actions to provide the containers. In general, the container engine daemon may perform actions to build and run the containers. In accordance with example implementations, one or multiple virtual machines may reside inside a given container, and one or multiple applications may execute inside a given virtual container. In another example, an application operating environment 156 may be a pod of containers. For example, an application operating environment 156 may be a pod of containers associated with a particular microservice.

A given file 132 contains data that may represent any of a wide variety of different content, or information. For example, an executable file 132 may store machine code (or “binary code”), which is directly executed. As a specific example, an executable file 132 may contain content that is directly executed to form an interpreter 150. The interpreter 150 contains machine code that is directly executed by the processor(s) 110, which is also referred to herein as being directly executed by the core 114 (or being directly executed by the kernel 112). In an example, an interpreter 150 may process an interpreted file 132 line by line, and this processing includes converting one or multiple commands of the line into machine code that may then be executed by a processor 110. In another example, an executable file 132 may store machine code that, when executed, forms an application 111 other than an interpreter 150.

In an example, an executable file 132 may have an identifying filename extension (e.g., an “.exe” extension), although other executable files 132 may not have extensions or extensions that identify the executable natures of the files 132. In another example, an executable file 132 may have associated metadata (e.g., metadata stored in the index node (or “inode”) associated with the file 132) that identifies the file 132 as being an execution file. In another example, an executable file 132 may be stored in a specific location (e.g., in a “/bin” directory folder) associated with executable files. In another example, an executable file 132 may have content that identifies the file 132 as being directly-executable.

A given file 132 may be an interpreted file. An “interpreted file,” in this context, refers to a file that contains code that is written in a programming language that is converted into machine code by an interpreter. As examples, an interpreted file 132 may be a PYTHON file, a hypertext preprocessor file (or “PHP” file), a JAVASCRIPT file, a Ruby file, a shell script file, or other file containing code that is interpreted, or transformed, by an appropriate interpreter into machine code for direct execution. In another example, an interpreted file 132 may have a filename extension (e.g., a “.py” extension) that associates the file 132 with a particular interpreter 150 (e.g., a PYTHON interpreter 150). In another example, an interpreted file 132 may have a main filename that associates the file 132 with a particular interpreter 150. In another example, an interpreted file 132 may have a content that identifies the file 132 as being an interpreted file. In another example, an interpreted file 132 may be stored in a particular location (e.g., a subfolder of the folder containing the corresponding interpreter 150) that identifies the file as being an interpreted file 132.

In another example, particular file 132 may be a configuration file. In this context, a “configuration file” refers to a file that controls the setup and/or operations of one or multiple components of the computer platform 100. In an example, the component may be an application 111, and a configuration file 132 may contain data that controls features and/or settings of the application 111. In another example, the component may be a hardware component (e.g., an expansion card or network interface), and a configuration file 132 may contain data that controls the setup and/or settings of the hardware component. In other examples, a configuration file 132 may contain data that controls the setup and/or settings of the overall computer system, a particular subsystem, a utility or a process. In an example, a configuration file 132 may have an identifying filename extension (e.g., a “.cfg” extension). In another example, a configuration file 132 may have associated metadata (e.g., metadata stored in the inode associated with the file 132) that identifies the file 132 as being a configuration file and/or associates the file as being associated with a particular application 111, process or utility. In another example, a configuration file 132 may have associated content that identifies the file 132 as being a configuration file and/or associates the file as being associated with a particular application 111, process or utility. In another example, a configuration file 132 may be stored in a specific location (e.g., in a “/etc” folder) associated with configuration files.

Other files 132 may be non-executable files that are not interpreted files or configuration files. In examples, a file 132 may store text content, financial data, application processing result data, audio data, audiovisual data, database records, video data, spreadsheet data or data representing other content. Moreover, a given non-executable file 132 may or may not affect the state of the computer platform 100, and a given non-executable file 132 may or may not be important to the security of the computer platform 100.

The core 114, in accordance with example implementations, includes components of an IMA, including an IMA measurement evaluation engine 115, an integrity measurement engine 180 and an appraisal engine 184. In an example, the IMA measurement evaluation engine 115 may determine whether or not certain software components of the computer platform 100 should be measured based on an IMA policy 113. The IMA policy 113 contains statements, or rules, that define the scope of certain integrity measurement-related actions (e.g., measurements and/or appraisals) for software components of the computer platform 100. In an example, a particular rule of the IMA policy 113 may contain an execute mask and specify an action. The execute mask causes the IMA measurement evaluation engine 115 to perform the specified action for all system calls directed to directly-executing files. In this manner, the rule causes the IMA measurement evaluation engine 115 to, in response to the kernel 112 receiving a system call to execute a particular file 132, perform the specified action on the file 132 before the file 132 is loaded into memory and executed.

In an example, the specified action may be an integrity measurement action, and the IMA measurement evaluation engine 115 may, before the file 132 is loaded into memory and executed by the core 114, initiate an integrity measurement of the file 132 by the integrity measurement engine 180. Another rule of the IMA policy 113 may specify an execute mask and an appraisal action. An “appraisal action” (or “appraisal”) refers to an operation that compares an integrity measurement to a reference integrity measurement and controls whether the file 132 may be executed based on a result of the comparison.

In accordance with example implementations, the integrity measurement is a hash. In the context used herein, a “hash” (which may also be referred to as a “hash,” “hash value,” “hash digest,” “cryptographic hash,” or “cryptographic hash value”) is produced by the application of a cryptographic hash function to a value (e.g., an input, such as the content of a file 132). A “cryptographic hash function” may be a function that is provided through the execution of machine-executable instructions by a processor (e.g., by provided one or multiple hardware processors 110 executing instructions as part of the measurement engine 180).

The cryptographic hash function may receive an input, and the cryptographic hash function may then generate a hexadecimal string to match the input. For example, the input may include a string of data (for example, the data structure in memory denoted by a starting memory address and an ending memory address). In such an example, based on the string of data the cryptographic hash function outputs a hexadecimal string. Further, any minute change to the input may alter the output hexadecimal string. In another example, the cryptographic hash function may be a secure hash function (SHA), any federal information processing standards (FIPS) approved hash function, any national institute of standards and technology (NIST) approved hash function, or any other cryptographic hash function. In some examples, instead of a hexadecimal format, another format may be used for the string.

The constraints (e.g., syntax and/or semantics constraints) imposed on the IMA policy 113 may not allow the rules of the IMA policy 113 to cover measurement-related actions for specific non-executable files 132. Certain non-executable files 132 (e.g., configuration files and interpreted files) may, however, be important to the security of the computer platform 100. Constructing rules having broad scopes (e.g., a rule that triggers measurements for all files within a volume or a rule that triggers measurements for all reads and/or writes) within the constraints that are imposed on the IMA policy 113 may overburden the IMA architecture and/or create considerable measurement noise. Moreover, for a commercially-provided core 114, modifying the core 114 to remove the constraints or at least change the constraints to allow specific non-executable files 132 to be covered by the IMA policy 113 may potentially void a warranty that covers the core 114.

In accordance with example implementations, the IMA policy scope is extended to cover specific non-executable files 132 via the inclusion of an extended integrity measurement evaluation engine 118 inside the kernel 112. In accordance with example implementations, the extended integrity measurement evaluation engine 118 is separate from the core 114, and the extended integrity measurement evaluation engine 118 is controlled by an extended integrity measurement policy 119. Unlike the IMA policy 113, the extended integrity measurement policy 119 may contain one or multiple rules that trigger measurement-related actions (e.g., measurements and appraisals) for specific non-executable files 132.

The extended integrity measurement policy 119 allows a rule to cover any specific non-executable file 132 or any specific class of non-executable files 132. In an example, the non-executable file 132 or class of non-executable files that are covered by a particular rule of the extended integrity measurement policy 119 may be important to the state of the computer platform 100. In an example, a rule of the extended integrity measurement policy 119 may cover a certain interpreted file or a certain class of interpreted files. In an example, a rule of the extended integrity measurement policy 119 may cover a certain configuration file or a certain class of configuration files. In another example, the non-executable file 132 or class of non-executable files that are covered by a particular rule of the extended integrity measurement policy 119 may not affect the state of the computer platform 100 and/or may not affect the security of the computer platform 100. For example, a rule of the extended integrity measurement policy 119 may cover a certain file or a certain class of files that are downloaded as part of a build process to build, on the computer platform 100, a software product that is distributed.

In accordance with some implementations, the kernel 112 may be a LINUX kernel, and the extended integrity measurement evaluation engine 118 may be added to the kernel 112 as an eBPF module. An eBPF module is a program that is outside of the compiled LINUX core (e.g., the core 114) and runs in a sandbox in a privileged context inside the LINUX kernel (e.g., the kernel 112). Although initially, the acronym “eBPF” referred to an “extended Berkeley Packet Filter,” the term “eBPF” is a standalone term that encompasses privileged context and sandboxed programs other than programs that perform packet filtering.

In accordance with example implementations, the extended integrity measurement policy 119 may contain a given rule that defines a file property-based selection criterion for purposes of selecting a file or class of files for a measurement-related action based on a file property characteristic (e.g., a filename, a filename extension, filename pattern, a file type, a file permission, a file modification date, a file creation date, a file size or other file property characteristic). In accordance with example implementations, a rule of the extended integrity measurement policy 119 may contain a context-based selection criterion for purposes of specifying a certain context characteristic (e.g., a namespace associated with the entity requesting access to a file or a file path of the file). In general, a given rule of the extended integrity measurement policy 119 may contain zero, one or multiple file property-based selection criteria, and the given rule may contain zero, one or multiple context-based selection criteria. The file property-based selection criterion/criteria (if any) and context-based selection criterion/criteria (if any) of a given rule of the extended integrity measurement policy 119 collectively define the condition for the rule, such that if the condition is satisfied for a particular file, a measurement-related action specified by the rule is performed.

In accordance with example implementations, the measurement engine 180 collects integrity measurements (as controlled by the engines 115 and 118 and policies 113 and 119) and for the collected integrity measurements, stores entries in a kernel space structure of the system memory 140, which represent and document the integrity measurements. For example, an entry may contain such information as a hash value corresponding to an integrity measurement of a file, a filename of the file and a hash value corresponding to the entire entry. Moreover, in accordance with some implementations, the entry may identify a particular location (e.g., a particular platform configuration register (PCR)) in a secure memory 166), which stores a measurement digest that corresponds to the measurement.

In accordance with some implementations, the secure memory 166 may be a set of PCRs of a security processor 163. The IMA architecture of the computer platform 100 may, in accordance with example implementations, perform a sequence of measurements during a measured boot of the computer platform 100 to establish a chain of trust for the computer platform 100. The root of the chain of trust may be, for example, a hardware boot block that measures and loads an initial set of firmware. The initial set of firmware may then be executed, and as part of this execution, the initial set of firmware measures and loads a next set of firmware. Pursuant to the measured boot, the construction of the chain of trust continues, with each component measuring the next component to be loaded and executed. The measurements that are collected during the measured boot may be used to build a measurement digest. For example, PCRs of the security processor 163 may be extended by the measurements taken during the measured boot to create a measurement digest that corresponds to the chain of trust.

The security processor 163 may also, as part of a root of trust for reporting (RTR), be capable of sending authenticated measurement information to a requesting device, such as a remote verifier 194, for purposes of attestation. In an example, the measurement information may include a measurement digest that is stored in the secure memory 166 of the security processor 160. Attestation, in general, refers to a process in which an electronic device, called a “verifier”, such as the remote verifier 194, determines whether another electronic device, such as the computer platform 100, is trustworthy. In an example, the remote verifier 194 may initiate attestation by challenging the computer platform 100 via an attestation request. In another example, the computer platform 100 may initiate attestation without prior contact or a challenge from the remote verifier 194. Regardless of how attestation is initiated, the security processor 163 may, as part of the attestation, send an authenticated measurement digest to the remote verifier 194. In this context, an “authenticated digest” refers to a set of measurements of the computer platform 100, which are signed by the security processor 163. A TPM quote (also called a “PCR quote”, which contains PCR values) is an example of an authenticated digest, although the authenticated digest may take on other forms, in accordance with further implementations.

In accordance with example implementations, the extended integrity measurement evaluation engine 118 may be used to extend the computer platform's measured boot-derived chain of trust further into user space. In this manner, in accordance with example implementations, a measurement digest that is constructed as part of the integrity measurements that collected as part of a measured boot of the computer platform 100 and the IMA policy 113 may be extended with the integrity measurements (e.g., integrity measurements of interpreted files and configuration files) that are collected due to the extended integrity measurement policy 119. The IMA measurement evaluation engine 115, in accordance with example implementations may, before the event-driven module 116 loaded and executed, measure and appraise the module 116. The integrity measurement of the event-driven module 116 therefore extends the measurement digest, and integrity measurements collected due to the execution of the module 116 are used to extend the measurement digest.

In accordance with example implementations, the core 114 calls the event-driven module 116 (and therefore instantiates an instance of the extended integrity measurement evaluation engine 118) in response to certain hooks (e.g., LINUX security module (LSM) hooks). In accordance with example implementation, a “hook” refers to a mechanism of the core 114 that allows program code outside of the core 114 (such as the event-driven module 116) to execute in response to a certain event. A hook may be registered with the core 114 for purposes of triggering execution of the event-driven module 116. In this context, registering a particular hook (such as a hook corresponding to a file event) with the core 114 generally refers to associating the execution of machine-executable instructions (e.g., the event-driven module 116) with a particular event (e.g., a file event) such that upon an occurrence of the event, control of the operating system 112 transfers to the machine-executable instructions so that the machine-executable instructions may be executed before control returns to the core 114. In accordance with example implementations, the event-driven module 116 is hooked into certain file events, such that when one of these file events occurs, the event-driven module 116 is executed.

As a specific example, in accordance with some implementations, for the LINUX operating system, a file_open hook (and more specifically, the Ism.s/file_open hook) may be used to initiate execution of the event-driven module 116 whenever a file 132 is accessed (read, written, executed or linked). As another example, a hook may initiate execution of the event-driven module 116 in response to a particular program execution operation. As another example, a hook may initiate execution of the event-driven module 116 in response to a file memory mapping operation.

As used here, an “engine” can refer to one or more circuits. For example, the circuits may be hardware processing circuits, which can include any or some combination of a microprocessor, a core of a multi-core microprocessor, a microcontroller, a programmable integrated circuit (e.g., a programmable logic device (PLD), such as a complex PLD (CPLD)), a programmable gate array (e.g., field programmable gate array (FPGA)), an application specific integrated circuit (ASIC), or another hardware processing circuit. An “engine” can refer to a combination of one or more hardware processing circuits and machine-readable instructions (software and/or firmware) executable on the one or more hardware processing circuits. In accordance with some implementations, the extended integrity measurement evaluation engine 118 may be formed by one or multiple processors 110 executing machine-readable instructions that are associated with the event driven module 116.

Among its other features, in accordance with example implementations, the computer platform 100 may include one or multiple input/output (I/O) bridges 120, which allow communications between the processors 110 and the security processor 163, as well as communications with the multiple storage devices 130; a video controller; a baseboard management controller (BMC) 160; as well as possibly other devices. More specifically, in accordance with some implementations, the bridge(s) 120 may include a north bridge that includes a memory controller (for system memory 140 accesses) and Peripheral Component Interconnect express (PCIe) root ports. Moreover, the bridge(s) 120 may include a south bridge that provides I/O ports, such as, for example, Serial Advanced Technology Attachment (SATA) ports, Universal Serial Bus (USB ports), Low Pin Count (LPC) ports, Serial Peripheral Interface (SPI) ports, extended SPI (eSPI) ports, and so forth. In accordance with some implementations, the north bridge may be part of the processors 110. In accordance with further implementations, the north and south bridges may be combined into a single bridge 120, and in accordance with some implementations, this single bridge 120 may be part of the processors 110. In accordance with some implementations, the bridge(s) 120 provide communication, via one or multiple buses (e.g., PCIe buses, Compute eXpress Link (CXL) buses or other communication links), with one or multiple smart I/O peripherals (not shown) of the computer platform 100.

In addition to executing machine-readable instructions to provide the operating system kernel 112, the processor(s) 110 may execute instructions to provide firmware runtime services, such as the UEFI runtime services 109 for the computer platform's runtime environment and provide firmware boot services (e.g., UEFI boot services and a basic input/output system (BIOS)) during the boot of the computer platform 100. The processor(s) 110 may also execute instructions to provide one or multiple application instances 111, one or multiple interpreter 150 instances and various other processes for the computer platform 100, such as a container daemon, a hypervisor, container instances, container pods, and virtual machine instances.

In accordance with example implementations, the computer platform 100 may have one or multiple network interface controllers (NICs) 121 to communicate with a remote verifier 194 via network fabric 190. The network fabric 190 may be associated with one or multiple types of communication networks, such as (as examples) Fibre Channel networks, CXL fabric, dedicated management networks, local area networks (LANs), wide area networks (WANs), global networks (e.g., the Internet), wireless networks, or any combination thereof.

In accordance with some implementations, the security processor 163 may be in the form of a chip that resides on the computer platform 100 separate from the main processors 110. In accordance with example implementations, the security processor 163 may be an integrated circuit that is built into a motherboard of the computer platform 100. In accordance with some implementations, the security processor 163 may be a virtual device (e.g., a virtual TPM).

The BMC 160 may provide various management services for the computer platform 100, such monitoring sensors (e.g., temperature sensors, cooling fan speed sensors); monitoring operating system status; monitoring power statuses; logging computer platform 100 events; providing remotely-controlled management functions for the computer platform 100; and so forth.

The BMC 160, in accordance with some implementations, may provide a security plane, which is isolated from its management plane. Using its security plane, the BMC 160 may provide various security services (e.g., secure storage for cryptographic security parameters, cryptographic services, cryptographic key sealing and unsealing, and other security services) for the computer platform 100. In accordance with some implementations, the BMC 160 may contain a silicon root of trust engine, which corresponds to the hardware root of the chain of trust for the computer platform 100. The silicon root of trust engine, in accordance with some implementations may, in response to the power up or reset of the computer platform 100, measure, load and executed initial security service-related firmware for the BMC 160 to begin the measured boot. In accordance with some implementations, the BMC 160 (instead of a security processor) may store and sign measurement digests for the computer platform 100, and the BMC 160 may provide an authenticated measurement digest for the computer platform 100 to a remote verifier 194.

As used herein, a “baseboard management controller,” or “BMC,” is a specialized service processor that monitors the physical state of a server or other hardware using sensors and communicates with a management system through a management network. The baseboard management controller may communicate with applications executing at the operating system level through an input/output controller (IOCTL) interface driver, a representational state transfer (REST) application program interface (API), or some other system software proxy that facilitates communication between the baseboard management controller and applications. The baseboard management controller may have hardware level access to hardware devices located in a server chassis including system memory. The baseboard management controller may be able to directly modify the hardware devices. The baseboard management controller may operate independently of the operating system of the computer platform 100. The baseboard management controller may be located on the motherboard or main circuit board of the server or other device to be monitored.

The fact that a baseboard management controller is mounted on a motherboard of the managed server/hardware or otherwise connected or attached to the managed server/hardware does not prevent the baseboard management controller from being considered “separate” from the server/hardware. As used herein, a baseboard management controller has management capabilities for sub-systems of a computing device, and is separate from a processing resource that executes an operating system of a computing device. As such, the baseboard management controller of the computer platform 100, as an example, is separate from the processor(s) 110, which execute the high-level operating system for the computer platform 100.

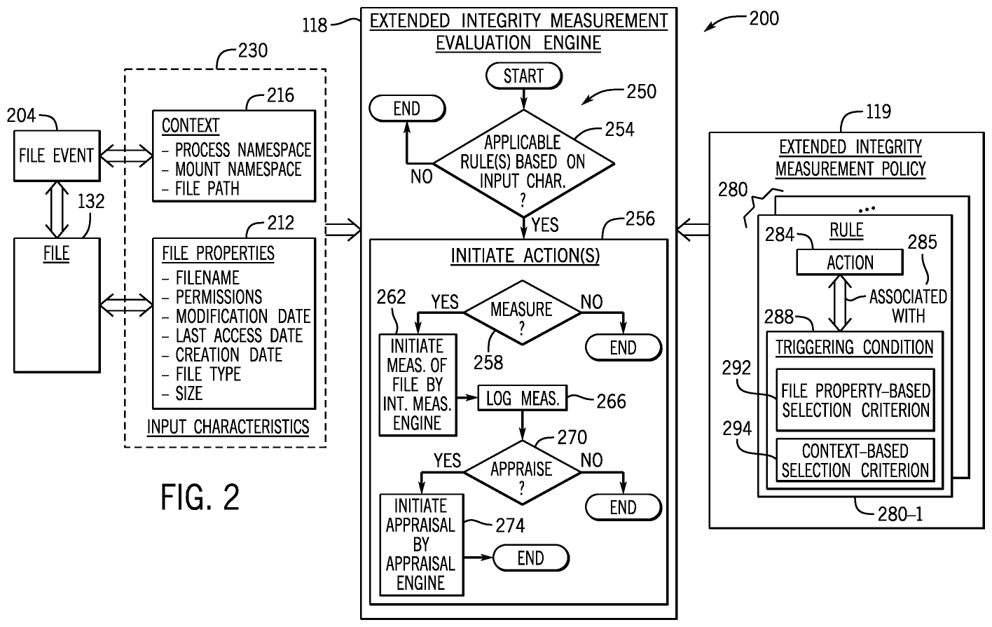

FIG. 2 depicts an illustration 200 of the extended integrity measurement engine's evaluation of a file 132 against an extended integrity measurement policy 119 according to an example implementation. For the following example, it is assumed that the file 132 is a non-executable file, i.e., a file 132 that is not directly executed. It is noted that per a non-extended IMA policy, a kernel core (and not the extended integrity measurement evaluation engine 118) may perform integrity measurement-related actions for executable files.

Referring to FIG. 2, the extended integrity measurement evaluation engine's evaluation of a file 132 occurs in response to a particular file event 204 that is associated with the file 132. In an example, the file event 204 may correspond to a system call to access the file 132, such as a system call to read from, write to, execute or link to the file 132. In other examples, the file event 204 may be a system call to memory map a file 132. The file event 204 may correspond to a particular kernel hook, such that the extended integrity measurement evaluation engine 118 is called in response to the file event 204 before kernel performs the corresponding action (e.g., read, write, execution or link) corresponding to the file event 204.

As depicted in FIG. 2, the file 132 may be associated with one or multiple file properties 212. As an example of a file property 212, the file 132 may have a filename (or “file name”). The filename may be, for example, a sequence of alphanumeric characters. The filename may or may not have an extension (e.g., cfg, .exe, and so forth).

In another example, a file property 212 may be a permission that is associated with the file 132. In an example, the permission may be a read permission (e.g., whether or not the file 132 can be read), a write permission (e.g., whether or not the file 132 can be written or modified) or an execute permission (e.g., whether or not the file 132 can be executed). Although for the example of FIG. 2, it is assumed that the file 132 is a non-executable file, the file 132 may nevertheless have an execute permission that allows execution of the file 132. For example, the file 132 may be an interpreted file that may be indirectly executed by an interpreter.

In accordance with example implementations, the file permissions may be described by metadata that is stored in an inode that corresponds to the file 132. The metadata may describe other file properties 212, such as, for example, a modification date, a last access date, a creation data, a file size or other attributes of the file 132.

The metadata may further describe a file type, another property 212 of the file 132. For example, with the LINUX 6 operating system, a file may have one of seven different file types: a regular file, a directory file, a link file, a character special file, a block special file, a socket file or a named pipe.

The file properties 212 form part of a set of input characteristics 230 that may be considered by the extended integrity measurement evaluation engine 118 when determining whether the file 132 falls within the scope of the extended integrity measurement policy 119. In addition to file properties 212, the extended integrity measurement evaluation engine 118 may, in accordance with example implementation, consider other input characteristics 230 that correspond to a context 216 that is associated with the file event 204. As depicted in FIG. 2, such context-related input characteristics 230 may include a namespace (e.g., a process namespace associated with the caller, a user namespace associated with the caller or a mount space associated with the caller) and a file path where the file 132 is stored.

In response to a file event 204 that corresponds to a particular file 132, the extended integrity measurement evaluation engine 118 filters rules 280 of the extended integrity measurement policy 119 in view of the corresponding input characteristics 230 for purposes of determining whether the file 132 is within the scope of the extended integrity measurement policy 119. In this context, “filtering” of the rules 280 generally refers to evaluating the rules 280 for purposes of determining whether any of the rules 280 are applicable to the file 132. If one or multiple rules 280 are determined to be applicable, then the file 132 is within the scope of the extended integrity measurement policy 119. In an example, the filtering may include the extended integrity measurement evaluation engine 118 traversing and evaluating each rule 280 based on one or multiple input characteristics 230 for purposes of determining whether the rule 280 applies to the file 132. In another example, the filtering may include the extended integrity measurement evaluation engine 118 applying a more directed approach in which a certain category or categories of rules 280 are first identified based on one or multiple input characteristics 230, and then the extended integrity measurement evaluation engine 118 searches the rules 280 within the category (ies). In another example, the filtering may include the extended integrity measurement evaluation engine 118 identifying a particular file property associated with the file 132, identifying any particular rule 280 that contains the file property as a criterion, and then evaluating logical expression(s) of the identified rule(s) 280. In another example, the filtering may include the extended integrity measurement evaluation engine 118 identifying a particular context associated with the file event 204, identifying any particular rule 280 that contains the context as a criterion, and then evaluating logical expression(s) of the identified rule(s) 280. Regardless of how the filtering is performed, if one or multiple rules 280 are within the scope of the extended integrity measurement policy 119, the extended integrity measurement evaluation engine 118 initiates the appropriate measurement-related action(s) 284 that are set forth by the applicable rule(s) 280, and then control of the processing of the file event 204 returns to the kernel core. Otherwise, if the extended integrity measurement evaluation engine 118 determines that the file 132 is outside the scope of the extended integrity measurement policy 119, the extended integrity measurement evaluation engine 118 returns control back to the kernel core without the engine 118 initiating any integrity measurement-related action for the file 132.

As depicted in FIG. 2, for an example rule 280-1, the rule 280-1 includes a trigger condition 288 (or “condition 288”) that is associated (as depicted at 285) with an integrity measurement-related action 284 (or “action 284”). The condition 288 identifies one or multiple criteria, which control whether the condition 288 is satisfied and consequentially, control whether the extended integrity measurement evaluation engine 118 initiates the action 284. Stated differently, the rule 280-1 has a condition 288 that is contingent on the file event 204 being associated with a particular criteria or criterion.

In an example, as depicted in FIG. 2, a particular rule 280, such as example rule 280-1, may contain a file property-based selection criterion 292 and a context-based selection criterion 294. Therefore, if the input characteristics 230 satisfy a condition 288 based on a logical combination of the file property-based selection criterion 292 and the context-based selection criterion 294, then the extended integrity measurement engine 118 initiates the associated measurement-related action 284.

In an example, a given rule 280 may contain a condition 288 that specifies a single file property-based criterion 292 and no context-based selection criterion 294. In another example, a given rule 280 may contain a condition 288 that specifies a single context-based criterion 294 and no file property-based selection criterion 292. In another example, a given rule 280 may contain a condition 288 that specifies multiple file property-based criteria 292. In another example, a given rule 280 may contain a condition 288 that specifies multiple context-based criteria 294. In another example, a given rule 280 may contain a condition 280 that specifies multiple file property-based criteria 292 and multiple context-based criteria 294.

Regardless of the particular criterion or criterion contained in a rule 280, the extended integrity measurement evaluation engine 118, in accordance with example implementations, initiates the action 284 specified by the rule 280 in response to the condition 288 of the rule 280 being met, or satisfied. In accordance with example implementations, a condition 288 of a rule 280 being met, or satisfied, refers to the input characteristics 230 having matches to all of the criterion or criteria of the condition 288.

In accordance with example implementations, more than one rule 280 of the extended integrity measurement policy 119 may apply to a given file 132. For example, multiple rules 280 of the extended integrity measurement policy 119 may specify measurement-related actions 284 for the same file 132. In a more specific example, one rule 280 may trigger a measurement of a non-executable file 132, and another rule 280 may trigger an appraisal for the non-executable file 132. As another example, multiple rules 280 of the extended integrity measurement policy 119 may collectively set the scope for certain files 132. For example, one rule 280 may set forth a condition 288 that covers a certain group, or class, of non-executable files 132, and this rule 280 may specify that the files 132 of the class are to be measured. Continuing the example, another rule 280 may set forth a condition 288 that covers a narrower subset of the class and specifies that the files 132 of the subset are not to be measured (i.e., here, the action 284 is an action not to be performed). Considering the two rules, extended integrity measurement evaluation engine 118 for this example, initiates measurements of files 132 that are within the class and not in the subset of the class.

In an example, a particular rule 280 of the extended integrity measurement policy 119 has a condition 288 that is defined by a logical AND of the criteria of the condition 288, such that if a file 132 and/or an associated context of the file event meet the criteria, the condition 288 is satisfied. In accordance with further implementations, whether or not a condition 288 is satisfied may be more logically more complex. In this manner, in accordance with some implementations, a condition 288 may specify a combinatorial logic expression (e.g., an expression containing one or multiple logical operators, such as ANDs, ORs, XORs and NOTs) for combining the criteria such that if the combinatorial expression produces a certain result (e.g., a Boolean True result), then the condition 288 is satisfied.

FIG. 2 depicts an exemplary process 250 that may be performed by the extended integrity measurement evaluation engine 118 in response to a particular file event 204. In an example, the process 250 may be called in response to a file hook that transfers control to an event-driven module (e.g., an eBPF module) of the kernel, and the process 250 may be performed by machine-readable instructions of the module being executed. Pursuant to decision block 254 of the process 250, the extended integrity measurement evaluation engine 118 determines whether there are any applicable multiple rules 280 that apply to the file event 204. Stated differently, pursuant to the process 250, the extended integrity measurement evaluation engine 118 determines whether the condition(s) 288 of one or multiple rules 280 are satisfied by the input characteristics 230.

If no applicable rules 280 apply to the input characteristics 230, then the extended integrity measurement evaluation engine 118 returns control back to the kernel core and the process terminates Otherwise, if one or multiple rules 280 are applicable, the extended integrity measurement evaluation engine 118 may then initiate one or multiple measurement-related actions associated with the applicable rule(s) 280, as depicted at 256. More specifically, as depicted at decision block 258, the extended integrity measurement evaluation engine 118 determines whether a measurement of the file 132 is to be initiated. If so, the extended integrity measurement evaluation engine 118 initiates measuring (block 262) and logging (block 266) of the file 132, which may be performed by the kernel's integrity measurement engine. The logging may involve, for example, the kernel storing an entry in kernel space representing the measurement and information about the measurement, and the logging may further include the kernel extending a measurement digest.

The extended integrity measurement evaluation engine 118 may also determine (decision block 270) whether an appraisal is to be performed. For example, one rule 280 may specify a measurement for the file 132, and another rule 280 may specify an appraisal. If no appraisal is to be performed, then the process 250 terminates and control returns back to the kernel's core. Otherwise, pursuant to block 274, the extended integrity measurement evaluation engine 118 initiates the appraisal by the kernel's appraisal engine and control returns back to the kernel core.

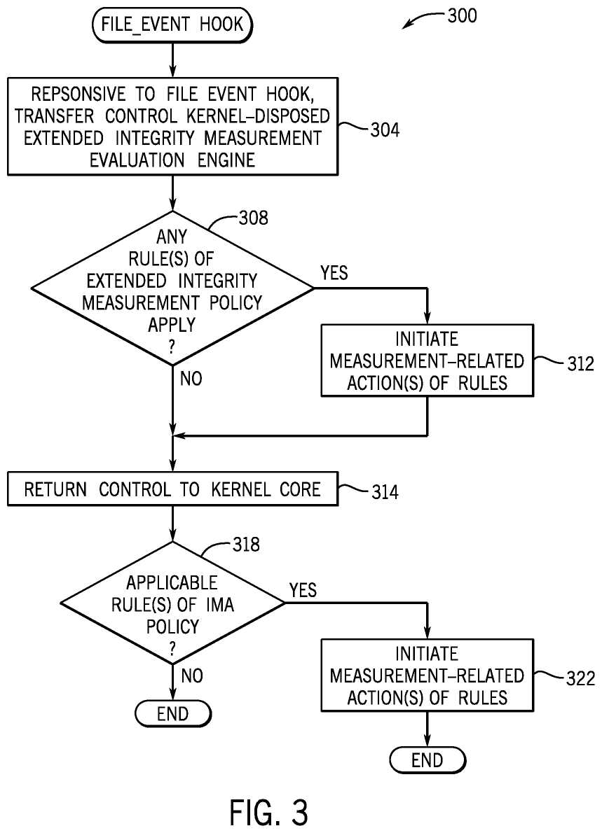

FIG. 3 depicts a technique 300 performed by an operating system kernel in response to a file event, in accordance with example implementation. The operating system kernel may have IMA components that are built into a compiled kernel core and an extended integrity measurement architecture that corresponds to a kernel-based event-driven module (e.g., an eBPF module). Referring to FIG. 3, the technique 300 may be triggered by a file event hook. In an example, the file event hook may be a hook corresponding to a file access event involving a read, write, execute or link. In another example, the file event hook may correspond to a memory mapping operation or may correspond to an execution operation. In an example, the hook may be a LINUX security module hook.

The technique 300 includes, pursuant to block 304, responsive to the file event hook, transferring control to an operating system kernel-disposed extended integrity measurement evaluation engine. In accordance with example implementations, the kernel instantiates an instance of the integrity measurement evaluation engine due to the file event and the corresponding file event hook. The extended integrity measurement evaluation engine may then determine, pursuant to decision block 308, whether any rule or rules of the extended integrity measurement policy apply. This determination may involve the extended integrity measurement evaluation engine evaluating input characteristics (e.g., file property characteristics, namespaces, file paths) associated with the file and/or file event with criteria (e.g., file property-based criteria and context-based criteria) of the rules of the extended integrity measurement policy to see if any of the rule conditions are satisfied. The rules may be constructed to target certain files based on file property-based criteria and/or context-based criteria. The rules may, in accordance with example implementations, target specific interpreted files and/or specific classes of non-executable files, such as interpreted files, configuration files or other non-executable files.

If, according to decision block 308, the extended integrity measurement evaluation engine determines that one or multiple rules apply, then according to block 312, the extended integrity measurement evaluation engine applies the action(s) of the rule(s). In examples, the actions may include actions to measure, appraise, not measure and not appraise.

As depicted in FIG. 3, after the above-described processing diversion due to the file event hook, control returns the kernel core, pursuant to block 314. The kernel core may then determine, pursuant to decision block 318, whether any IMA policy rules apply and if so, perform the measurement-related action(s) of the rule(s), pursuant to block 322.

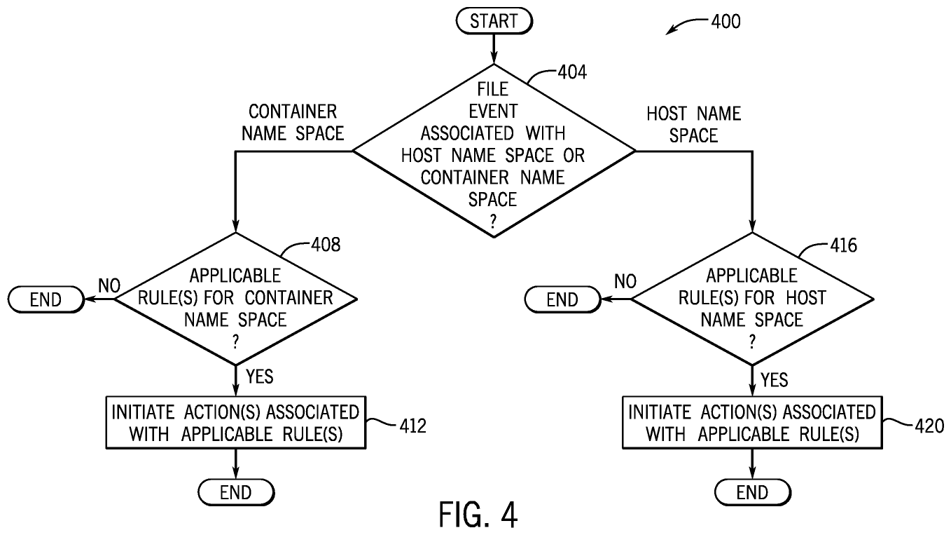

FIG. 4 depicts an exemplary technique 400 for selecting and applying a rule of an extended integrity measurement policy based on a namespace that is associated with a file event, in accordance with example implementations. Referring to FIG. 4, the technique 400 includes determining (decision block 404) whether the event is associated with a host namespace or a container namespace. As depicted in FIG. 4, if the event is associated with a host namespace, then, pursuant to decision block 416, a determination is made whether one or multiple applicable rules exist for the host namespace. If so, then the appropriate actions associated with the rule(s) are initiated, pursuant to block 420.

If, pursuant to decision block 404, a determination is made that the event is associated with a container namespace, then a determination may be made, pursuant to decision block 408, whether one or multiple applicable rules exist for the container namespace. In accordance with some implementations, measurements may not be made, for example, for files that are accessed in the container namespace. If, pursuant to decision block 408, one or multiple applicable rules are identified, then control proceeds to block 412 in which the associated action(s) are initiated.

The technique 400 may be particular advantageous for covering integrity measurement-related actions for files that may be accessed by both the host and a container. If a volume is mounted on a host with the intention of being used by a container, then the volume or any file therein may be purposefully excluded from the scope of a traditional namespace-unaware IMA policy due to the way in which IMA measurements are logged. In this manner, when a file is accessed within the context of the container, a measurement of that file would be added to the IMA log on the host with the path relative to that of the container. The host may then fail an attestation as the path and/or measurement does not match the reference path and/or reference measurement for the host. One way to prevent this from happening with a namespace-unaware IMA policy is to exclude the volume from integrity measurements. Such an approach may, however, allow an attacker to access the volume and execute files without measurement by the IMA. As depicted by the technique 400, due to the namespace awareness of the extended integrity measurement policy, the namespace associated with the requestor may be considered as part of the determination of whether to measure a file.

Therefore, as an example, a namespace-aware rule of the extended integrity measurement policy may be constructed to trigger measurements of files of a volume that will be mounted into a container if the files are accessed by the host, but the rule does not trigger measurements of the same files if the files are accessed by the container. In this way, integrity measurements are made for the files of the volume and logged in a way that allows verification of the integrity measurements.

In accordance with further implementations, a namespace-aware rule of the extended measurement policy may trigger a measurement-related action (e.g., a measurement or an appraisal) for certain files (e.g., files of a particular volume) that are accessed by a particular container but not trigger any measurement-related actions for the same files when accessed by the host. This may beneficial, for example, when measurements are logged using container file path references.

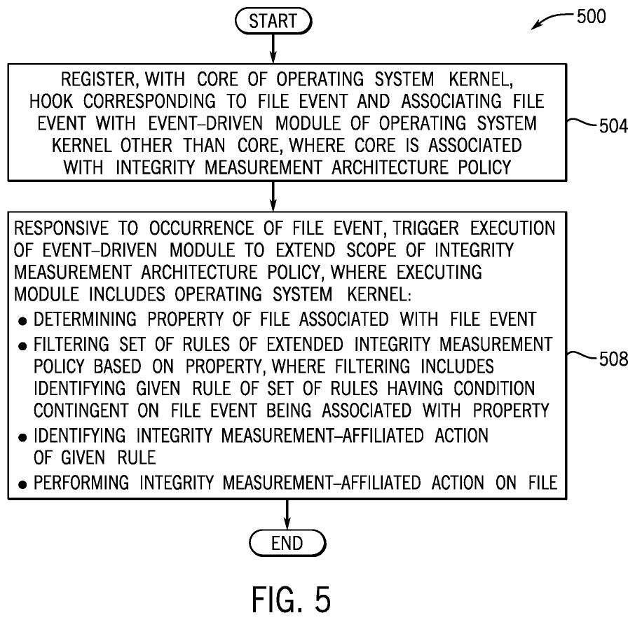

Referring to FIG. 5, in accordance with example implementations, a technique 500 includes registering (block 504), with a core of an operating system kernel, a hook that corresponds to a file event and associates the file event with an event-driven module of the operating system kernel other than the core. The core is associated with an integrity measurement architecture policy. The file event may be associated with a file. In accordance with example implementations, the file may be a non-executable file. In an example, a non-executable file may be a configuration file. In another example, a non-executable file may be an interpreted file.

In accordance with example implementations, the file event may be a file access event, such as an event corresponding to a system call to read from a file, write to a file, link a file or execute a file. In another example, the file event may be an event corresponding to a system call to memory map a file. In an example, the operating system may be a LINUX operating system, and the hook may be a LINUX security module (LSM) hook.

In accordance with example implementations, the technique 500 includes, responsive to an occurrence of the file event, triggering (block 508) execution of the event-driven module to extend a scope of the integrity measurement architecture policy. Executing the event-driven module includes the operating system kernel determining a property (a “file property”) of a file that is associated with the file event and filtering a set of rules of an extended integrity measurement policy based on the property. The filtering includes identifying a given rule of the set of rules having a condition that is contingent on the file event being associated with the property. Executing the event-driven module includes identifying an integrity measurement-affiliated action of the given rule and performing the integrity measurement-affiliated action on the file. In an example, a file property may be a filename. In an example, a file property may be a filename pattern, such as combination of alphanumeric characters appearing in the filename or a filename extension. In an example, a file property may be a modification date, creation date or access date of the file. In an example, a file property may be represented by metadata that is stored in an inode corresponding to the file. In an example, a file property may be a file type. In an example, a file property may be a permission (e.g., a read, write or execute permission) associated with the file. In an example, a file property may be a size of the file. In an example, filtering the set of rules may include evaluating logical expressions contained in the rules.

In an example, a measurement-affiliated action may be an action to measure the file. In another example, a measurement-affiliated action may be an action to appraise the file. In another example, a measurement-affiliated action may be a direction to not perform a particular action (e.g., NOT perform an appraisal).

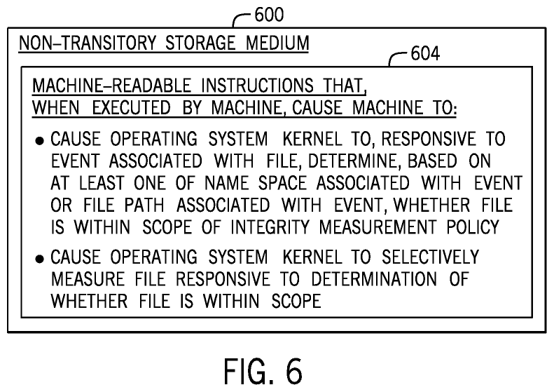

Referring to FIG. 6, in accordance with example implementations, a non-transitory storage medium 600 stores machine-readable instructions 604. The instructions 604, when executed by a machine, cause the machine to cause an operating system kernel to, responsive to an event that is associated with a file, determine, based on at least one of a namespace associated with the event or a file path associated with the event, determine whether the file is within a scope of an integrity measurement policy. In an example, the event may be a file access event. In an example, the file access event may be an event to read from, write to or execute the file.

In an example, the namespace may be a process namespace. In an example, the namespace may be a mount namespace. In an example, the namespace may be a user namespace.

In an example, determining whether the file is within a scope of an integrity measurement policy includes evaluating rules that are set forth in the integrity measurement policy. In accordance with example implementations, causing the operating system kernel to determine whether a file is within a scope of an integrity measurement policy includes hooking into a kernel core. In an example, a LINUX security module (LSM) hook may be used. In an example, determining whether the file is within a scope of an integrity measurement policy includes determining whether the namespace associated with the event is a criterion of a rule of the integrity measurement policy. In an example, determining whether the file is within the scope of the integrity measurement policy includes determining whether the file path associated with the event is a criterion set forth in a rule of the integrity measurement policy.

In an example, the machine-readable instructions may be instructions associated with an event-driven module of the operating system kernel. In an example, the machine-readable instructions may be instructions of an eBPF module.

The instructions 604, when executed by the machine, further cause the machine to cause the operating system kernel to selectively measure the file responsive to the determination of whether the file is within the scope. In an example, measuring the file may include applying a hash function to content of the file to provide a corresponding hash value. In accordance with example implementations, the instructions may cause the machine to appraise the file. In an example, appraising the file may include comparing a measurement of the file to a trusted reference measurement of the file. In accordance with example implementations, selectively measuring the file includes not measuring the file.

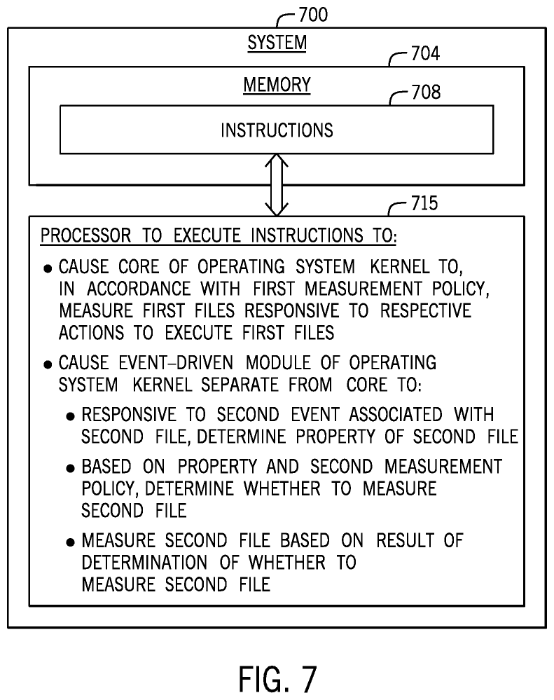

Referring to FIG. 7, in accordance with example implementations, a system 700 includes a memory 704 and a processor 715. The memory 704 includes instructions 708. The processor 715 executes the instructions 708 to cause a core of an operating system kernel to, in accordance with a first measurement policy, measure first files responsive to respective actions to execute the first files.

In an example, the instructions to cause the core to measure the first files includes instructions corresponding to an integrity measurement architecture (IMA) of the core. In accordance with example implementations, the instructions to cause the core to measure the first files is responsive to an action to execute the first files. In an example, the first files may include direct executables.

The processor 715 further executes the instructions 708 to cause an event driven module of the operating system kernel separate from the core to, responsive to a second event that is associated with a second file, determine a property of the second file. In an example, a property may be a filename of the file. In an example, a property may be a pattern associated with a filename of the file. In an example, a property may be a property identified by metadata associated with the file. In an example, a property may be a file type of the file. In an example, a property may be a size of the file. In an example, a property may be a modification date of the file. In an example, a property may be a permission of the file.

In an example, the second file may be a file that is not directly executed by the processor. In an example, the second file may be an interpreted file that is executed by an interpreter. In an example, the interpreter may be directly executed by the processor. In an example, the second file may be a configuration file.

The processor 715 further executes the instructions 708 to, based on the property and a second measurement policy, determine whether to measure the second file. The determination of whether to measure the second file may be based on a property of the second file, a namespace associated with the event, or a file path associated with the event. Determining whether to measure the second file may include determining whether a condition of a rule of the second measurement policy applies to the property of the second file.

The processor 715 further executes the instructions 708 to selectively measure the second file based on a result of the determination of whether to measure the second file. In an example, the determination may include the processor identifying a rule that identifies the property as a criterion to satisfy the rule, and the rule may be associated with a measurement action. In accordance with some implementations, the event-driven module may be a module that executes in a sandbox of the kernel with privileges. In an example, the event-driven module may be an eBPF module.

In accordance with example implementations, the property is an execute permission. Identifying the given rule includes determining that the file has the execute permission. A particular advantage is that integrity measurements may be extended to include specific non-executable files.

In accordance with example implementations, the property includes a file type, and identifying the given rule includes determining that the condition specifies a file type characteristic that corresponds to the file type. A particular advantage is that integrity measurements may be extended to include specific non-executable files.

In accordance with example implementations, the property includes a filename, and identifying the given rule includes determining that the condition specifies a filename characteristic that corresponds to the filename. A particular advantage is that integrity measurements may be extended to include specific non-executable files.

In accordance with example implementations, the property includes a file creation date, and identifying the given rule includes determining that the condition specifies a file creation date characteristic that corresponds to the file creation date. A particular advantage is that integrity measurements may be extended to include specific non-executable files.

In accordance with example implementations, the file event is associated with a context. Identifying the given rule includes determining that the condition specifies a context characteristic that corresponds to the context. A particular advantage is that integrity measurements may be extended to include specific non-executable files.

In accordance with example implementations, the context includes a namespace, and identifying the given rule further includes determining that the condition specifies a namespace characteristic that corresponds to the namespace. A particular advantage is that integrity measurements may be extended to include specific non-executable files.

In accordance with example implementations, the context includes a file path, and identifying the given rule further includes determining that the condition specifies a file path characteristic that corresponds to the file path. A particular advantage is that integrity measurements may be extended to include specific non-executable files.

In accordance with example implementations, the file includes a configuration file or an interpreted file. A particular advantage is that integrity measurements may be extended to include specific non-executable files.

In accordance with example implementations, the event-driven module includes machine-executable instructions that run in a privileged context and inside a sandbox. A particular advantage is that integrity measurements may be extended to include specific non-executable files.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
registering, with a core of an operating system kernel, a hook corresponding to a file event and associating the file event with an event-driven module of the operating system kernel other than the core, wherein the core is associated with an integrity measurement architecture policy; and
responsive to an occurrence of the file event, triggering execution of the event-driven module to extend a scope of the integrity measurement architecture policy, wherein executing the module comprises the operating system kernel:
determining a property of a file associated with the file event;
filtering a set of rules of an extended integrity measurement policy based on the property, wherein the filtering comprises identifying a given rule of the set of rules having a condition contingent on the file event being associated with the property;
identifying an integrity measurement-affiliated action of the given rule; and
performing the integrity measurement-affiliated action on the file.

2. The method of claim 1, wherein the file has an execute permission, and identifying the given rule comprises determining that the condition is contingent on the file having the execute permission.

3. The method of claim 1, wherein the property comprises a file type, and identifying the given rule comprises determining that the condition specifies a file type characteristic that corresponds to the file type.

4. The method of claim 1, wherein the property comprises a filename, and identifying the given rule comprises determining that the condition specifies a filename characteristic that corresponds to the filename.

5. The method of claim 1, wherein the property comprises a file creation date, and identifying the given rule comprises determining that the condition specifies a file creation date characteristic that corresponds to the file creation date.

6. The method of claim 1, wherein:
the file event is associated with a context; and
identifying the given rule comprises determining that the condition specifies a context characteristic that corresponds to the context.

7. The method of claim 6, wherein:
the context comprises a namespace, and identifying the given rule further comprises determining that the condition specifies a namespace characteristic that corresponds to the namespace.

8. The method of claim 6, wherein:
the context comprises a file path, and identifying the given rule further comprises determining that the condition specifies a file path characteristic that corresponds to the file path.

9. The method of claim 1, wherein the file comprises a configuration file or an interpreted file.

10. The method of claim 1, wherein the event-driven module comprises machine-executable instructions that run in a privileged context and inside a sandbox.

11. A non-transitory machine-readable storage medium that stores machine-readable instructions that, when executed by a machine, cause the machine to:
cause an operating system kernel to, responsive to an event corresponding to a file, determine, based on at least one of a namespace associated with the event or a file path associated with the event, whether the file is within a scope of an integrity measurement policy; and
cause the operating system kernel to selectively measure the file responsive to the determination of whether the file is within the scope.

12. The storage medium of claim 11, wherein the instructions, when executed by the machine, further cause the machine to, responsive to determining that the file is within the scope, apply a hash function to a content of the file to determine a hash value representing a measurement of the file.

13. The storage medium of claim 11, wherein:
a first namespace is associated with a host of the machine, and a second namespace is associated with a container running on the host;
the integrity measurement policy associates a measurement action with the first namespace; and
the instructions, when executed by the machine, further cause the operating system kernel to measure the file responsive to determining that the namespace associated with the event corresponds to the first namespace.

14. The storage medium of claim 11, wherein:
a first namespace is associated with a host of the machine, and a second namespace is associated with a container running on the host; and
the instructions, when executed by the machine, further cause the operating system kernel to bypass measuring the file responsive to determining that the namespace associated with the event corresponds to the second namespace.

15. The storage medium of claim 11, wherein the instructions, when executed by the machine, further cause the operating system kernel to determine whether the file is within the scope of the integrity measurement policy based on a file property-based selection criterion.

16. The storage medium of claim 15, wherein the file property-based selection criterion comprises a file type characteristic, a file permission characteristic, a filename characteristic or a file modification date characteristic.

17. A system comprising:
a memory to store instructions; and
a processor to execute the instructions to:
cause a core of an operating system kernel to, in accordance with a first measurement policy, measure first files responsive to respective actions to execute the first files; and
cause an event-driven module of the operating system kernel separate from the core to:
responsive to a file event associated with a second file, determine a property of the second file;
based on the property and a second measurement policy, determine whether to measure the second file; and
selectively measure the second file based on a result of the determination of whether to measure the second file.

18. The system of claim 17, wherein the second file comprises a configuration file or an interpreted file.

19. The system of claim 17, wherein the instructions, when executed by the processor, further cause the event-driven module to determine to measure the second file based on the property of the file and at least one of a namespace associated with the event or a file path associated with the event.

20. The system of claim 17, wherein the property comprises a file type characteristic, a file permission characteristic, a filename characteristic or a file modification date characteristic.
